(19) United States
(12) Patent Application Publication
(10) Pub. No.: US 2017/0289537 A1
(43) Pub. Date: Oct. 5, 2017

(54) Signal Detection Method and Signal Detection Device

(71) Applicant: MStar Semiconductor, Inc., Hsinchu Hsien (TW)

(72) Inventors: Chih-Hsun LIN, Hsinchu Hsien (TW); Fang-Ming YANG, Hsinchu Hsien (TW); Chih-Cheng KUO, Hsinchu Hsien (TW); Tai-Lai TUNG, Hsinchu Hsien (TW)

(21) Appl. No.: 15/397,849

(22) Filed: Jan. 4, 2017

(30) Foreign Application Priority Data
Mar. 30, 2016 (TW) 105110013

(51) Int. Cl. H04N 17/00; H04L 27/34; H04B 17/30

(52) U.S. Cl. CPC H04N 17/004; H04B 17/30; H04L 27/34

(57) ABSTRACT

A signal detection method detects a digital signal in a channel. The signal detection method includes: performing a power operation and a frequency transformation operation on a signal of the channel to obtain at least one frequency-domain power set; and determining whether the channel carries the digital signal according to the at least one frequency-domain power set.

This application claims the benefit of Taiwan application Serial No. 105110013, filed Mar. 30, 2016, the subject matter of which is incorporated herein by reference.

### BACKGROUND OF THE INVENTION

### Field of the Invention

The invention relates in general to a signal detection method and a signal detection device, and more particularly to a signal detection method and a signal detection device capable of promptly detecting in a channel whether the channel includes a digital signal.

### Description of the Related Art

With the blooming of multimedia and the Internet, demands of common households for high-speed transmission have exponentially increased, and cable modems with a large bandwidth have gradually gained popularity among consumers. For digital television applications, a cable modem performs channel scanning on a plurality of television channels. More specifically, a cable modem detects in a television channel whether the television channel includes digital television signals. If the digital television channel does not include any digital television signals, the cable modem switches to another digital television channel to detect whether this another digital television channel includes digital television signals. In the prior art, signal detection that a cable modem performs is not based on characteristics of a digital television signal, results in a way that the cable modem may spend a loner period on channel scanning.

Therefore, there is a need for a solution for the above issue.

### SUMMARY OF THE INVENTION

The invention is directed to a channel detection method capable of promptly eliminating non-digital signals to overcome the issue of the prior art.

The present invention discloses a signal detection method for detecting a digital signal of a channel. The signal detection method includes: performing a power operation and a frequency transformation operation on a signal of the channel to obtain at least one frequency-domain power set; and determining whether the channel carries the digital signal according to the at least one frequency-domain power set.

The present invention further discloses a signal detection device for detecting a digital signal in a channel. The signal detection device includes: a power operation circuit; a frequency transformation circuit, coupled to the power operation circuit, wherein the power operation circuit and the frequency transformation circuit perform a power operation and a frequency transformation operation on a signal of the channel to obtain at least one frequency-domain power set; and a determination circuit, determining whether the channel carries the digital signal according to the at least one frequency-domain power set.

The above and other aspects of the invention will become better understood with regard to the following detailed description of the preferred but non-limiting embodiments. The following description is made with reference to the accompanying drawings.

### BRIEF DESCRIPTION OF THE DRAWINGS

FIG. 1 is a flowchart of a signal detection process according to an embodiment of the present invention;

FIG. 2 is a schematic diagram of a signal;

FIG. 3 is a flowchart of an operation process according to an embodiment of the present invention;

FIG. 4 is a flowchart of a detection process according to an embodiment of the present invention;

FIG. 5 is a block diagram of a signal detection device according to an embodiment of the present invention; and

FIG. 6 is a block diagram of a signal detection device according to another embodiment of the present invention.

### DETAILED DESCRIPTION OF THE INVENTION

The IUT-T J38B standard is extensively applied in digital television systems. According to the IUT-T J38B standard, a digital television signal is modulated by quadrature amplitude modulation (QAM). However, a QAM signal is characterized in that, an ensemble average of this QAM signal to the power of 4 is a constant. More specifically, assuming that a signal S is a signal modulated by the QAM technology, an ensemble average of the signal S to the power of 4 (denoted as S⁴), denoted as E[S⁴], is a constant; that is, E[S⁴]=C (where C is a constant). That is to say, time-domain sample values S₁ to S_{N} of the signal S in the time-domain are characterized by E[S⁴]=C. In the above situation, when a frequency transformation operation, e.g., a fast Fourier transform (FFT), is performed on the values E[S₁⁴] to E[S_{N}⁴], the corresponding frequency transformation results R₁ to R_{N} are expected to approximate an impulse function; that is, a frequency transformation result Rₘ among the frequency transformation results R₁ to R_{N} is far greater than other frequency transformation results among the frequency transformation results R₁ to R_{N}. Using the foregoing characteristic of QAM, the present invention detects whether a digital signal modulated by QAM is carried in a channel.

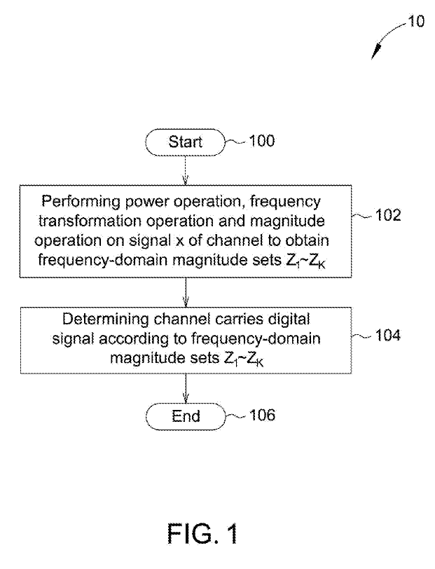

FIG. 1 shows a flowchart of a signal detection process 10 according to an embodiment of the present invention. The signal detection process 10 is applied to detect whether a channel includes a digital signal that is a signal modulated by the QAM technology. Using the above characteristic of QAM, the signal detection process 10 promptly detects whether the channel includes the digital signal. The signal detection process 10 may be applied to a cable modem, such that the cable modem may perform the signal detection process 10 to promptly detect whether a digital television channel includes a J.83B signal (the J.83B signal is modulated by the QAM technology). If the digital television channel does not include the J.83B signal, the signal detection process 10 switches to another digital television channel to perform channel scanning (i.e., detecting whether this another digital television channel includes a J.83B signal). The signal detection process 10 may be performed by a signal detection device, and includes following steps.

In step 100, the signal detection process 10 begins.

In step 102, a power operation, a frequency transformation operation and a magnitude operation are performed on a signal x of a channel to obtain frequency-domain magnitude sets Z₁ to Z_{K}.

In step 104, it is determined whether the channel carries the digital television signal according to the frequency-domain magnitude sets Z₁ to Z_{K}.

In step 106, the signal detection process 10 ends.

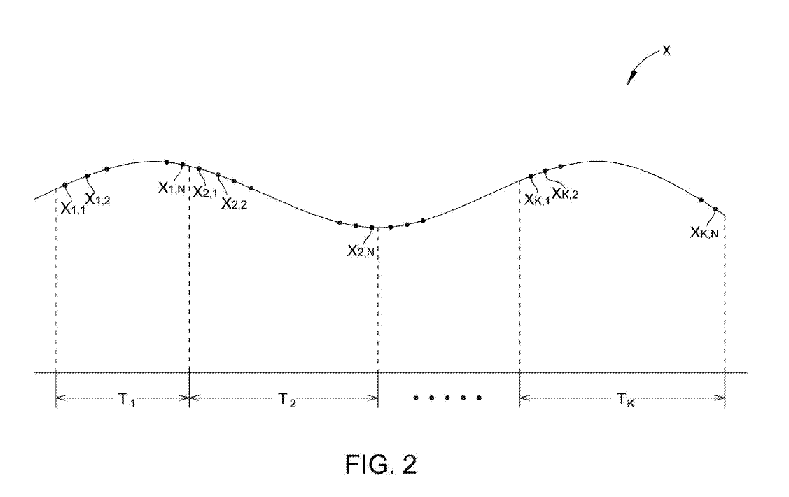

Operation details of the signal detection process 10 are given as below. In step 102, the signal detection device performs the power operation, the frequency transformation operation and the magnitude operation on the signal to obtain the frequency-domain order magnitude sets Z₁ to Z_{K}. The power operation is a 4^{th}-power operation, and the frequency transformation operation is an FFT operation. More specifically, as shown in FIG. 2, the signal detection device may sample the signal x in time intervals T₁ to T_{K} to obtain time-domain sample sets X₁ to X_{K}. Taking the time interval T₁ for example, the signal detection device samples the signal x in the time interval T₁ to obtain the time-domain sample set X₁, which includes time-domain sample values X_{1, 1}, to X_{1, N}. Using a mathematical vector, the time-domain sample set X₁ may be represented as X1=[X_{1, 1}, to X_{1, N}]^{T}, where [ ]^{T} represents a transpose operator. Similarly, for any time interval Tₖ, the time-domain sample set Xₖ includes time-domain sample values X_{k, 1} to X_{k, N}; that is, the time-domain sample set Xₖ may be represented as Xₖ=[X_{k, 1}, . . . , X_{k, N}]^{T}.

Further, the signal detection device performs a power operation (i.e., 4^{th}-power operation) on the time-domain sample sets X₁ to X_{K} to obtain power sets X₁⁴ to X_{K}⁴, respectively. More specifically, when the signal detection device performs a power operation on the time-domain sample set Xₖ, the signal detection device performs a power operation on each of the time-domain sample values X_{k, N} in the time-domain sample set X_{K} to obtain a power value X_{k, n}⁴, which represents the time-domain sample value _{k, n} raised to the 4^{th} power. In other words, any sample set Xₖ⁴ in the sample sets X₁⁴ to X_{K}⁴ includes power values X_{k, 1}⁴ to X_{k, N}⁴, and so the power set Xₖ⁴ may be represented as Xₖ⁴=[X_{k, 1}, . . . , X_{k, N}]^{T}.

Further, the signal detection device performs a frequency transformation operation on the power sets X₁⁴ to X_{K}⁴ to obtain frequency-domain power sets Y₁ to Y_{K}, in which any frequency-domain power set Yₖ (or frequency-domain power values Y_{k, 1} to Y_{k, N}) is a result of the power set Xₖ⁴ having undergone the frequency transformation operation. In other words, the frequency-domain power value Yₖ may be represented as Yₖ=FFT(Xₖ⁴), where FFT( ) represents an FFT operator. More specifically, the frequency-domain power set Yₖ includes frequency-domain power values Y_{k, 1} to Y_{k, N}, and the frequency-domain power set Yₖ may be represented as Yₖ=[Y_{k, 1}, . . . , Y_{k, N}]^{T}=FFT(Xₖ⁴).

Further, the signal detection device performs a magnitude operation on the frequency-domain power sets Y₁ to Y_{K} to obtain frequency-domain magnitude sets Z₁ to Z_{K}, in which any frequency-domain magnitude set Zₖ includes frequency-domain magnitude values Z_{k, 1} to Z_{k, N}. A frequency-domain magnitude value Zₖ, n in the frequency-domain magnitude values Z_{k, 1} to Z_{k, N} is the magnitude value of the corresponding frequency-domain power value Y_{k, n}. In other words, the frequency-domain magnitude value Z_{k, N} may be represented as Z_{k, N}=|Y_{k, n}|=abs(Y_{k, n}), wherein |•| and abs( ) both represent magnitude operators.

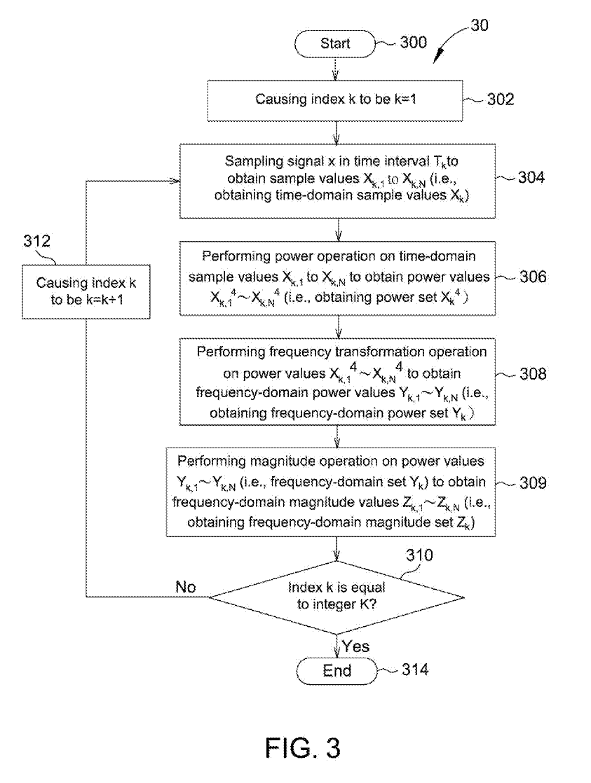

Operations of how the signal detection device performs the power operation, the frequency transformation operation and the magnitude operation on the signal x to obtain the frequency-domain magnitude sets Z₁ to Z_{K} may be further concluded to an operation process 30. FIG. 3 shows an operation process 30 according to an embodiment of the present invention. The operation process 30 may be performed by the signal detection device, and includes following steps.

In step 300, the operation process 30 begins.

In step 302, the index k is caused to be k=1.

In step 304, the signal x is sampled in the time interval Tₖ to obtain the time-domain sample values X_{k, 1} to X_{k, N} (i.e., obtaining the time-domain sample set Xₖ).

In step 306, the power operation is performed on the time-domain power values X_{k, 1} to X_{k, N} to obtain the power values X_{k, 1}⁴ to X_{k, N}⁴ (i.e., obtaining the power set Xₖ⁴).

In step 308, the frequency transformation operation is performed on the power values X_{k, 1}⁴ to X_{k, N}⁴ to obtain the frequency-domain power values Y_{k, 1} to Y_{k, N} (i.e., obtaining the frequency-domain power set Yₖ).

In step 309, the magnitude operation is performed on the frequency-domain power values Y_{k, 1} to Y_{k, N} (i.e., the frequency-domain power set Yₖ) to obtain the frequency-domain magnitude values Z_{k, 1} to Z_{k, N} (i.e., obtaining the frequency-domain magnitude set Zₖ).

In step 310, it is determined whether the index k is equal to an integer K. Step 314 is performed if so, otherwise step 312 is performed.

In step 312, the index k is caused to be k=k+1, and step 304 is iterated.

In step 314, the operation process 30 ends.

According to the time intervals T₁ to Tₖ, the operation process 30 samples and performs the power operation and the frequency transformation operation on the signal x to obtain the frequency-domain magnitude sets Z₁ to Z_{K}, where the integer K is an integer greater than 1. The remaining operation details of the operation process 30 may be referred from the foregoing description, and are omitted herein for brevity.

Further, in step 104, the signal detection device adds up the frequency-domain magnitude sets Z₁ to Z_{K} to obtain a frequency-domain accumulation set P. The frequency-domain sum set P may be represented as

$$P = {\sum }_{k = 1}^{K} {Z}_{k} ,$$

includes frequency-domain accumulation values P₁ to P_{N}, and may also be represented as P=[P₁, . . . , R_{N}]^{T}. In other words, any frequency-domain Pₙ in the frequency-domain accumulation values P₁ to P_{N} may be represented as

$${P}_{n} = {\sum }_{k = 1}^{K} {Z}_{k , n} .$$

When the channel carries the digital signal modulated by QAM, the frequency-domain accumulation values P₁ to P_{N} are expected to approximate an impulse function, i.e., a maximum frequency-domain accumulation value Pₘₐₓ in the frequency-domain accumulation values P₁ to P_{N} is far greater than the remaining accumulation values. Thus, the signal detection device may determine whether the channel carries the digital signal according to the frequency-domain accumulation values P₁ to P_{N}. In one embodiment, the signal detection device may obtain the maximum frequency-domain accumulation value Pₘₐₓ in the frequency-domain accumulation values P₁ to P_{N}, and determine that the channel does not carry the digital signal (e.g., a J.83B signal) when it determines that the maximum frequency-domain accumulation value Pₘₐₓ is in a first predetermined range. For example, when the signal detection device determines that the maximum frequency-domain accumulation value Pₘₐₓ is smaller than a threshold Pₜₕ₁, the signal detection device determines that the channel does not carry the digital signal, wherein the threshold Pₜₕ₁ may be adjusted based on actual conditions.

Further, in one embodiment, the signal detection device may calculate a ratio of the maximum frequency-domain accumulation value Pₘₐₓ to a plurality of adjacent frequencies adjacent to the maximum frequency-domain accumulation value Pₘₐₓ. When the signal detection device determines that the ratio is in a second predetermined range, the signal detection device determines that the channel does not carry the digital signal. How the signal detection device calculates the ratio of the maximum frequency-domain accumulation value Pₘₐₓ to the plurality of adjacent frequencies adjacent to the maximum frequency-domain accumulation value Pₘₐₓ is not limited. For example, the signal detection device may first calculate an average value Pₐᵥ of the plurality of adjacent frequencies adjacent to the maximum frequency-domain accumulation value Pₘₐₓ, and then calculate a ratio R of the maximum frequency-domain accumulation value Pₘₐₓ to the average value Pₐᵥ.

More specifically, the signal detection device may first obtain a maximum frequency Q corresponding to the maximum frequency-domain accumulation value Pₘₐₓ. The maximum frequency Q is the frequency where the maximum frequency-domain accumulation value Pₘₐₓ is located, and may be represented as

$$Q = arg {max}_{n} {P}_{n} .$$

Further, the signal detection device obtains a plurality of adjacent frequencies Q−M−L to Q−M and a plurality of frequencies Q+M to Q+M+L adjacent to the maximum frequency Q according to the maximum frequency Q, and selects adjacent frequency-domain accumulation values P_{Q-M-L} to P_{Q-M} and P_{Q+M} to P_{Q+M+L} corresponding to the adjacent frequencies Q−M−L to Q−M and Q+M to Q+M+L from the frequency-domain accumulation values P₁ to P_{N}. After obtaining the adjacent frequency-domain accumulation values P_{Q-M-L} to P_{Q-M} and P_{Q+M} to P_{Q+M+L}, the signal detection device may further calculate an average value Pₐᵥ of the adjacent frequency-domain accumulation values P_{Q-M-L} to P_{Q-M} and P_{Q+M} to P_{Q+M+L}, that is the average value Pₐᵥ may be represented as

$${P}_{av} = ( {\sum }_{n = Q - M - L}^{Q - M} {P}_{n} + {\sum }_{n = Q + M}^{Q + M + L} {P}_{n} ) / 2 L .$$

The signal detection device may then calculate that the ratio R is R=Pₘₐₓ/Pₐᵥ after obtaining the average value Pₐᵥ, where M and L may be non-negative integers. As such, when the signal detection device determines that the ratio R is in the second predetermined range, the signal detection device may determine that the channel does not carry the digital signal. For example, when the signal detection device determines that the ratio R is greater than a threshold Pₜₕ₂ or smaller than a threshold Pₜₕ₃, the signal detection device may determine that the signal does not carry the digital signal (e.g., a J.83B signal), where the thresholds Pₜₕ₂ and Pₜₕ₃ may be adjusted based on actual conditions.

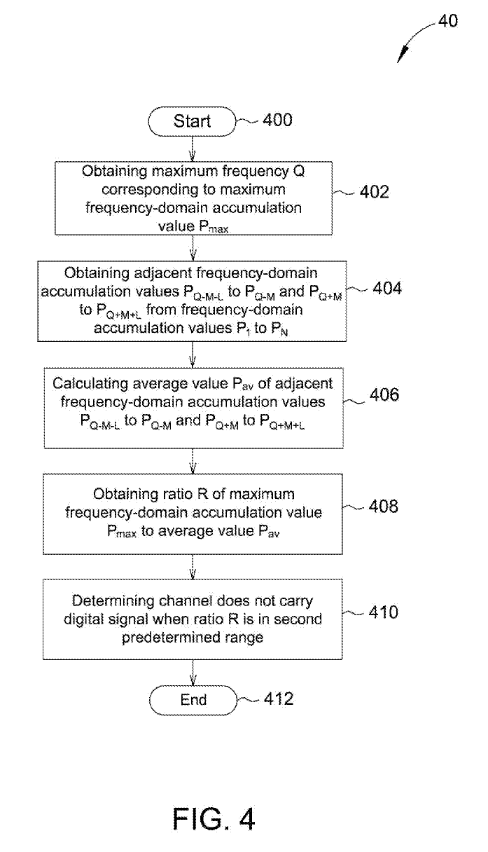

Operations of how the signal detection device determines whether the channel carries the digital signal according to the maximum frequency-domain accumulation value Pₘₐₓ may be concluded to a detection process 40. FIG. 4 shows a flowchart of the detection process 40 according to an embodiment of the present invention. The detection process 40 may be performed by the signal detection process, and includes following steps.

In step 400, the detection process 40 begins.

In step 402, the maximum frequency Q corresponding to the maximum frequency-domain accumulation value Pₘₐₓ is obtained.

In step 404, from the frequency-domain accumulation values P₁ to P_{N}, the adjacent frequency-domain accumulation values P_{Q-M-L} to P_{Q-M} and P_{Q+M} to P_{Q+M}+L are obtained.

In step 406, the average value Pₐᵥ of the adjacent frequency-domain accumulation values P_{Q-M-L} to P_{Q-M} and P_{Q+M} to P_{Q+M+L} is calculated.

In step 408, the ratio R of the maximum frequency-domain accumulation value Pₘₐₓ to the average value Pₐᵥ is obtained.

In step 410, when the ratio R is in the second predetermined range, it is determined that the channel does not carry the digital signal.

In step 412, the detection process 40 ends.

The detection process 40 determines that the channel does not carry the digital signal according to the ratio R of the maximum frequency-domain accumulation value Pₘₐₓ to the adjacent frequency-domain accumulation values P_{Q-M-L} to P_{Q-M} and P_{Q+M} to P_{Q+M+L} (adjacent to the maximum frequency Q). Other operation details of the detection process 40 may be referred from the foregoing description, and such repeated details shall be omitted for brevity.

According to the signal detection process 10, the signal detection device is capable of promptly detecting whether the channel carries the digital signal. When the signal detection device determines that the channel does not carry the digital signal, the signal detection device may switch to detect another channel. In other words, the signal detection device of the present invention is capable of reducing the signal detection time for detecting whether the channel carries the digital signal.

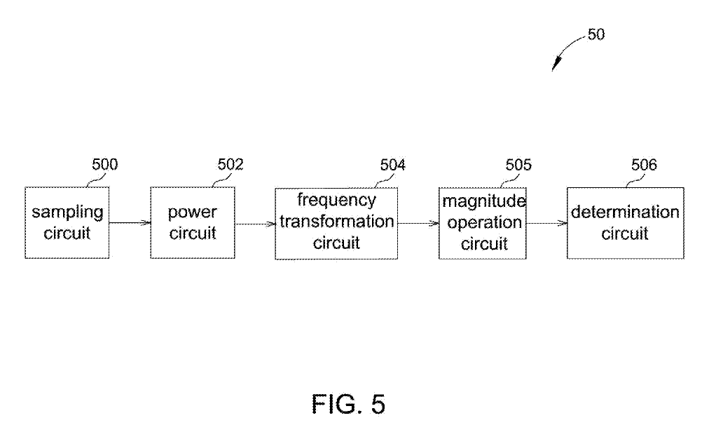

The signal detection device is not limited to be implemented in a particular structure. For example, FIG. 5 shows a block diagram of a signal detection device 50 according to an embodiment of the present invention. The signal detection device 50 includes a sampling circuit 500, a power operation circuit 502, a frequency transformation circuit 504, a magnitude operation circuit 505 and a determination circuit 506. The sampling circuit 500 samples the signal x to obtain time-domain sample values X_{1, 1} to X_{K, N} (or time-domain sample sets X₁ to X_{K}). The power operation circuit 502 performs the power operation on the time-domain sample values X_{1, 1} to X_{K, N} to obtain power values X_{1, 1}⁴ to X_{K, N}⁴ (or power sets X₁⁴ to X_{K}⁴). The frequency transformation circuit 504 may be an FFT module, and performs the frequency transformation operation on the power values X1, 1⁴ to X_{K, N}⁴ to obtain frequency-domain power values Y_{1, 1} to Y_{K, N} (or frequency-domain power sets Y₁ to Y_{K}). The magnitude operation circuit 505 performs the magnitude operation on the frequency-domain power values Y_{1, 1} to Y_{K, N} to obtain frequency-domain magnitude values Z_{k, 1} to Z_{k, N}. The determination circuit 506 determines whether the channel carries the digital signal according to the frequency-domain magnitude values Z_{k, 1} to Z_{k, N}. In other words, the sampling circuit 500, the power operation circuit 502, the frequency transformation circuit 504 and the magnitude operation circuit 505 perform step 102 of the signal detection process 10 and the operation process 30, and the determination circuit 506 performs step 104 of the signal detection process 10 and the detection process 40. The sampling circuit 500, the power operation circuit 502, the frequency transformation circuit 504 and the determination circuit 506 may be implemented by application-specific integrated circuits (ASIC).

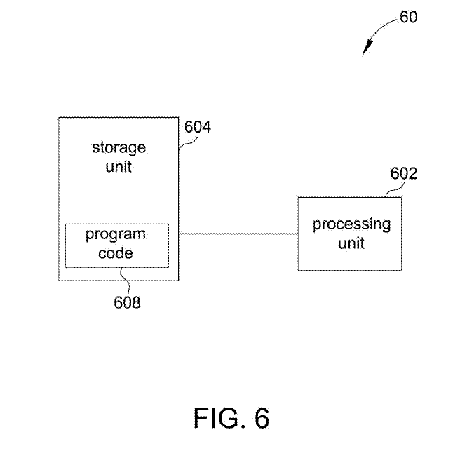

FIG. 6 shows a block diagram of a signal detection device 60 according to an embodiment of the present invention. The signal detection device 60 includes a processing unit 602 and a storage unit 604. The signal detection process 10, the operation process 30 and the detection process 40 may be coded to a program code 608 and stored in the storage unit 604 to instruct the processing unit 602 to perform the signal detection process 10, the operation process 30 and the detection process 40. The processing unit 602 may be, for example but not limited to, a central processing unit (CPU), a digital signal processor (DSP) or a microprocessor. The storage unit 604 may be, for example but not limited to, a read-only memory (ROM), or a non-volatile memory (e.g., an electrically-erasable programmable read-only memory (EEPROM), or a flash memory).

The foregoing embodiments are for illustrating the concept of the present invention, and one person skilled in the art can make appropriate modifications to the embodiments. For example, in the signal detection process 10, the operation process 30 and the detection process 40, the integer K is an integer greater than 1. In other embodiments, the integer may also be equal to 1. That is, the signal detection device may sample a signal and perform the power operation and the frequency transformation operation on signal in one time interval only to obtain one single frequency-domain power set, and determine whether the channel carries the digital signal according to this one single frequency-domain power set. Such modification is also encompassed within the scope of the present invention.

In conclusion, using QAM characteristics, the present invention promptly detects whether a channel carries a digital signal modulated by QAM, and is capable of reducing the signal detection time needed for detecting non-digital signals in the channel. When the signal detection device detects that the channel does not carry the digital signal, the signal detection device switches to detect another channel, hence reducing the overall time needed for channel scanning.

While the invention has been described by way of example and in terms of the preferred embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A signal detection method, detecting a digital signal in a channel, comprising:
performing a power operation and a frequency transformation operation on a signal of the channel to obtain at least one frequency-domain magnitude set; and
determining whether the channel carries the digital signal according to the at least one frequency-domain magnitude set.

2. The signal detection method according to claim 1, wherein the step of performing the power operation and the frequency transformation operation on the signal to obtain the at least one frequency-domain magnitude set comprises:
sampling the signal in a first time interval to obtain a plurality of time-domain sample values;
performing the power operation on the plurality of time-domain sample signals to obtain a plurality of power values;
performing the frequency transformation operation on the plurality of power values to obtain a plurality of frequency-domain power values;
performing a magnitude operation on the plurality of frequency-domain power values to obtain a plurality of frequency-domain magnitude values; and
obtaining a first frequency-domain magnitude set corresponding to the first time interval, wherein the first frequency-domain magnitude set comprises the plurality of frequency-domain magnitude values;
wherein, the plurality of magnitude values of the plurality of frequency-domain power values that the magnitude operation obtains are the plurality of frequency-domain magnitude values.

3. The signal detection method according to claim 1, wherein the power operation is a 4^{th}-power operation.

4. The signal detection method according to claim 1, wherein the frequency transformation operation is a fast Fourier transform (FFT) operation.

5. The signal detection method according to claim 1, wherein the step of determining whether the channel carries the digital signal according to the at least one frequency-domain magnitude set comprises:
adding up the at least one frequency-domain magnitude set to obtain a plurality of frequency-domain accumulation values; and
determining whether the channel carries the digital signal according to the plurality of frequency-domain accumulation values.

6. The signal detection method according to claim 5, wherein the step of determining whether the channel carries the digital signal according to the plurality of frequency-domain accumulation values comprises:
obtaining a maximum frequency-domain accumulation value in the plurality of frequency-domain accumulation values; and
determining whether the channel carries the digital signal according to the maximum frequency-domain accumulation value.

7. The signal detection method according to claim 6, wherein the step of determining whether the channel carries the digital signal according to the maximum frequency-domain accumulation value comprises:
determining that the channel does not carry the digital signal when the maximum frequency-domain accumulation value is in a first predetermined range.

8. The signal detection method according to claim 6, wherein the step of determining whether the channel carries the digital signal according to the maximum frequency-domain accumulation value comprises:
obtaining a maximum frequency corresponding to the maximum frequency-domain accumulation value;
obtaining a plurality of adjacent frequency-domain accumulation values from the plurality of frequency-domain accumulation values; and
determining whether the channel carries the digital signal according to the maximum frequency-domain accumulation value and the plurality of adjacent frequency-domain accumulation values.

9. The signal detection method according to claim 8, wherein the step of determining whether the channel carries the digital signal according to the maximum frequency-domain accumulation value and the plurality of adjacent frequency-domain accumulation values comprises:
calculating an average value of the plurality of adjacent frequency-domain accumulation values;
obtaining a ratio of the maximum frequency-domain accumulation value to the average value; and
determining that the channel does not carry the digital signal when the ratio is in a second predetermined range.

10. A signal detection device, detecting a digital signal of a channel, comprising:
a power operation circuit;
a frequency transformation circuit, coupled to the power operation circuit;
a magnitude operation circuit, coupled to the frequency transformation circuit, wherein the power operation circuit, the frequency transformation circuit and the magnitude operation circuit perform a power operation, a frequency transformation operation and a magnitude operation on a signal of the channel, respectively, to obtain at least one frequency-domain magnitude set; and
a determination circuit, determining whether the channel carries the digital signal according to the at least one frequency-domain magnitude set.

11. The signal detection device according to claim 10, further comprising:
a sampling circuit, coupled to the power operation circuit;
wherein, the sampling circuit samples the signal in a first time interval to obtain a plurality of time-domain sample values, the power operation circuit performs the power operation on the plurality of time-domain sample values to obtain a plurality of power values, the frequency transformation circuit performs the frequency transformation operation on the plurality of power values to obtain a plurality of frequency-domain power values, the magnitude operation circuit performs the magnitude operation on the plurality of frequency-domain power values to obtain a first frequency-domain magnitude set comprising a plurality of frequency-domain magnitude values corresponding to the first time interval, and the magnitude operation obtains a plurality of magnitude values of the plurality of frequency-domain power values as the plurality of frequency-domain magnitude values.

12. The signal detection device according to claim 10, wherein the power operation is a 4^{th}-power operation.

13. The signal detection device according to claim 10, wherein the frequency transformation operation is a fast Fourier transform (FFT) operation.

14. The signal detection device according to claim 10, wherein the determination circuit determines whether the channel carries the digital signal according to the at least one frequency-domain magnitude set by further performing steps of:
adding up the at least one frequency-domain magnitude set to obtain a plurality of frequency-domain accumulation values; and
determining whether the channel carries the digital signal according to the plurality of frequency-domain accumulation values.

15. The signal detection device according to claim 14, wherein the determination circuit determines whether the channel carries the digital signal according to the plurality of frequency-domain accumulation values by further performing steps of:
obtaining a maximum frequency-domain accumulation value in the plurality of frequency-domain accumulation values; and
determining whether the channel carries the digital signal according to the maximum frequency-domain accumulation value.

16. The signal detection device according to claim 15, wherein the determination circuit determines whether the channel carries the digital signal according to the maximum frequency-domain accumulation value by further performing a step of:
determining that the channel does not carry the digital signal when the maximum frequency-domain accumulation value is in a first predetermined range.

17. The signal detection device according to claim 15, wherein the determination circuit determines whether the channel carries the digital signal according to the maximum frequency-domain accumulation value by further performing a step of:
obtaining a maximum frequency corresponding to the maximum frequency-domain accumulation value;
obtaining a plurality of adjacent frequency-domain accumulation values from the plurality of frequency-domain accumulation values; and
determining whether the channel carries the digital signal according to the maximum frequency-domain accumulation value and the plurality of adjacent frequency-domain accumulation values.

18. The signal detection device according to claim 17, wherein the determination circuit determines whether the channel carries the digital signal according to the maximum frequency-domain accumulation value and the plurality of adjacent frequency-domain accumulation values further by performing steps of:
calculating an average value of the plurality of adjacent frequency-domain accumulation values;
obtaining a ratio of the maximum frequency-domain accumulation value to the average value; and
determining that the channel does not carry the digital signal when the ratio is in a second predetermined range.
